(19) United States
(12) Patent Application Publication
(10) Pub. No.: US 2009/0253110 A1
(43) Pub. Date: Oct. 8, 2009

(54) School focus

(76) Inventor: Ludwig Franz Hurtado, San Jose, CA (US)

Correspondence Address: LUDWIG FRANZ HURTADO, 1584 BLOSSOM HILL ROAD, # 2, SAN JOSE, CA, 95118, US

(21) Appl. No.: 12/080,832

(22) Filed: Apr. 7, 2008

(51) Int. Cl. G09B 5/00

(52) U.S. Cl. 434/307 R

(57) ABSTRACT

School Focus is a product created to improve learning, reduce class truancy, raise revenues for schools, teachers local, state and federal government. This product uploads audio and video from within classrooms through the internet onto a School Focus computer. The computer converts audio into text and attaches website links to the transcription. School Focus places the notes and links onto a website and sell them in different digital formats. School Focus creates an income stream for schools, teachers, state and federal government. School Focus divides the revenue it receives from the sale of products and services amongst the aforementioned groups. School Focus snaps pictures of students who are known truant and emails them to parents and law enforcement.

### CROSS REFERENCE TO RELATED APPLICATION

None are known at this time.

### STATEMENT OF FEDERALLY SPONSORED RESEARCH OR DEVELOPMENT

None exist with this invention.

### BACKGROUND OF INVENTION

School Focus is an invention that solves problems that are present in the academic sector. Problems exist with students taking notes, while paying attention to the instructor. While paying attention to the instructor a student is required to listen and remember what is being taught. While remembering what is being taught a student is required to organize his thoughts, look away from the instructor down onto the desk, focus on spelling, coordinate his hands and memory to write down a condensed record of the lecture all, while maintaining focus on the ensuing lesson. The problem is present when you combine different tasks, while paying attention to the instructor. Students encounter a condition of reduced learning readiness through deprivation of focus and loss of conscious receptivity.

Other problems exist with notes and note taking. Notes are only a brief entry or record of the lesson, thus at times notes are incomplete or useless, because students lose focus and comprehension occurs when a student is looking down and writing instead of looking up and listening to the instructor.

Additional problems with note taking exists. Notes are exposed to being lost or damaged. Due to the fragile nature of paper notes are readily of no use. Students regularly attend several different classes. Each class that they go to requires note taking. Thus as a result a student is required to carry additional weight along with the many other books.

A problem exists with the amount of time teachers spend in re-explaining, repeating or going over material previously taught. It is common knowledge that students do not always comprehend the lessons taught. As a result of the students failure to understand they are required to go to their instructor for a repeat or re-explanation of what was taught. The problem occurs, when a teacher receives many different requests from many students. Since an instructor is required to exhaust all remedies to assure the students comprehension, an instructor is forced to use up, deplete or spend his time on re-explaining the lesson.

Problems exist with the high number of truant students. A school suffers financial loss when students fail to show up to class. Due to the schools loss of revenue, educators set up a system to inform parents of their child's truancy. The problem with the system that was set up allowed for easy interception by the child. Phone calls and letters are not a secure and effective form of informing parents of students. As a result the problem of ensuring that parents are informed immediately after the child cuts class was still existent.

Problems exist in raising money for teachers, schools and for state and federal government. The money set aside for schools barely gives teacher a fair pay. Thus a problem is evident, when teachers are constantly complaining about their salaries.

Before School Focus was created problems associated with parental involvement were present. With the current state of technology parents can not fully be made aware of their child's homework assignments. Parents are required to rely on the memory of their child. Due to the fact that younger students do not take education seriously they are prone to misrepresent their teachers expectations and homework assignments and as a result are unable to provide their children support or assistance on subjects and topics taught in class. Prior to School Focus parents with younger students could not know what happened at school. Parents were also restricted to their child's memory when they asked what they learnt in school that day. As a result parents were not able to be made aware of their child's progress on a daily basis, unless they spoke with the instructor. The problem with relying daily on the instructor was the consumption that one parent would require of the teachers, instructors time.

### SUMMARY OF THE INVENTION

School Focus is an invention that introduces various new functions and applications for the internet and for internet driven technologies. School Focus eliminates the need for note taking in class by students who are listening and paying attention to the instructor. School Focus system captures entire lessons in audio and video. It converts entire lessons into text. The lessons are kept on a database over the internet and are made available in complete audio, video and text. Students can download the notes directly from the internet and can also view a repeat of the lesson in complete audio and video format. Students also can have the entire lesson in audio and video downloaded to their cellphone, pda or other internet hand held devices. Students now with School Focus have the option to have notes in full audio and video format with fast forward, rewind or loop options. When the lesson is converted into text students can search specific words and have access to precise portions of the lesson that they are reviewing. School Focus also will make available on cd, dvd, text or other digital formats entire seasons of lectures and lessons with additional material commentaries and extras added by the instructor. The entire lessons will be available hours, days, weeks, months or years after the class has been taught.

School Focus saves teachers across the United States millions of hours in repeating, re-explaining or going over lessons previously taught. A student who did not fully absorb, understand or comprehend the lesson can go on the internet and review the lesson instead of consuming the instructors time. Instructors now have the ability to have lessons repeated for them, without them having to use up their time. School Focus provides an options to teachers never before available. With the old state of technology when an instructor is absent the lessons pile up and this creates a cramming of lessons. If the teacher taught the same class the previous year then the curriculum can easily be taught on schedule with School Focus play back option. Students and teachers can stay on focus, course and schedule instead of falling behind with the lesson. So as a result of the teacher's absence class can continue via School Focus web site. If a substitute teacher has the class the substitute can more effectively continue teaching where the permanent teacher left off.

School Focus has invented a new form to raise millions of dollars for State and Federal Government, instructors and schools. School Focus will raise millions of dollars for the academic sector. School Focus generates money from its customers who access its storage base over the internet. School Focus receives money from fees charged for access of School Focus database. School Focus will also sell entire lessons in cd dvd, blue ray, and all digital file including book and text notes. School Focus converts the recorded lesson into a product which could be viewed at a later time from home or other location.

The fees that are received by School Focus are divided amongst teachers, schools, state governments, federal government and School Focus's parent company.

School Focus creates thousands of jobs in maintenance, quality control, security, setup, repair, upkeep, programming, administration and other tech positions. The creation of these jobs will generate tax revenue for state and federal entities.

School Focus will reduce the number of truant students. This invention will offer parents a new and unique manner in monitoring their child's attendance. The School Focus system will snap pictures of the students attending class and will email the photos of the classroom to the parents of the students. With School Focus technology parents are able to be informed of their childs attendance, without having school notices intercepted. Current state laws place parents responsible for their childs truancy. Before School Focus was developed parents had no tools to provide them real time information on their childs attendance.

School Focus creates the opportunity to involve parents participation in their young students education, because now parents can share, re-enforce at home the daily lesson. This occurs now because parents have an understanding of the material covered daily. In the past parents only had the memory of their child.

School Focus offers long distance parents the opportunity to be more fully aware of their childs progress. Due to some long distance parental relationships parents have been excluded in the education of their child. In the past no technology was set up to bridge the distance gap between long distance and parental involvement. Now parents can discuss with their children the lessons taught. School Focus gives parents topics to discuss at the dinner table.

### DESCRIPTION OF DRAWINGS

FIG. 1 Power Notes

FIG. 1 is a drawing of how power notes works. A-1 represents the classrooms across the United States. Inside the classrooms are computer systems that capture audio and video through its web cams and microphones this system is represented as A-2. A-3 is the feed from the computer consisting of audio and video being sent through an internet connection whether high speed or other slow connection. The audio and video feed is sent to School Focus head quarters technology department represented as B-2. Once the technology department receives the audio and video from the classroom it prepares the audio and converts it to text through manual and electronic transcription. This process is shown as B-5. Once the audio is made into text the audio is combined with hyper links and web pages that have reference to the material taught in class. This process is labeled B-4 and it represents the preparation of the text and combined webpages, hyperlinks and other internet references to complete the process of perfecting the transcribed audio into a text document with links to other sites. It is combined to create B-7 text notes with web page references. It is sent to be published to the web site and this process is B-8. C-1 is the School Focus home page where audio and video and text notes are placed for all users to view, listen, print, download or link up with other sites of reference. B-10 is the process of which School Focus headquarters sends the video and audio to the site and makes them available for all registered users. D-1 are students who log onto the web site to D-4 obtain audio, video and text notes through downloads and requests to have automatic email of audio, video and text notes D-5 D-11 is the automatic download of all notes, video, audio and text sent to students.

FIG. 2 Billions of dollars raised for Schools & Government

FIG. 2 is a drawing of the process A-1 is the classrooms across the United States, A-2 is the computer system placed by School Focus which captures the audio and video from the classrooms and it sends it to B-School Focus Technology Department B-2 assures that the audio, video and power notes are all published onto the web site C-1 where D-1 students log on to view, listen print and download notes D-4 and students also request automatic emails of audio, video and text to cell phones or other hand held internet ready devices. School Focus will receive money for purchase of dvd's of entire semesters, days weeks months as needed by students E-1. Parent's of students D-2 who want to be involved in their young child's education will log onto School Focus web site D-6 and view listen and print lessons taught. They can also have automatic downloads to cell phones or other hand held internet ready devices. Parents D-2 will pay E-1 to School Focus for various services or purchases as well as other users who seek the information on our web site. B-3 is the financial department of School Focus. B-3 is the department where School Focus receives money from sales, services and other associated fees. The money received is divided and a percentage of the profits are given to E-2 teachers, E-3 schools E-4 state government and E-5 federal government.

FIG. 3 Truancy Reduced

FIG. 3 is a depiction of how truancy is reduced by implementing the following system. A-1 classrooms across the United States are constantly diminishing in attendance due to students truancy. School Focus places computer systems A-2 inside classrooms which uploads audio and video feed from the classroom to School Focus servers B-2. The cameras are designed to snap pictures of a special area where known truant student is suppose to sit. The pictures will be uploaded onto the School Focus network B-2. School Focus will forward the imaged to D-2 parents of the known truant students. This will inform parents of the attendance of the student and thus will give parents I-1 the ability to check on the truant student during the act of truancy. This provides for I-2 which provides parents real time information on their childs attendance. Parents can more adequately deal with their child's attendance and not have to wait until the school notifies them days, months or weeks later.

FIG. 4 Time saving tool for teachers

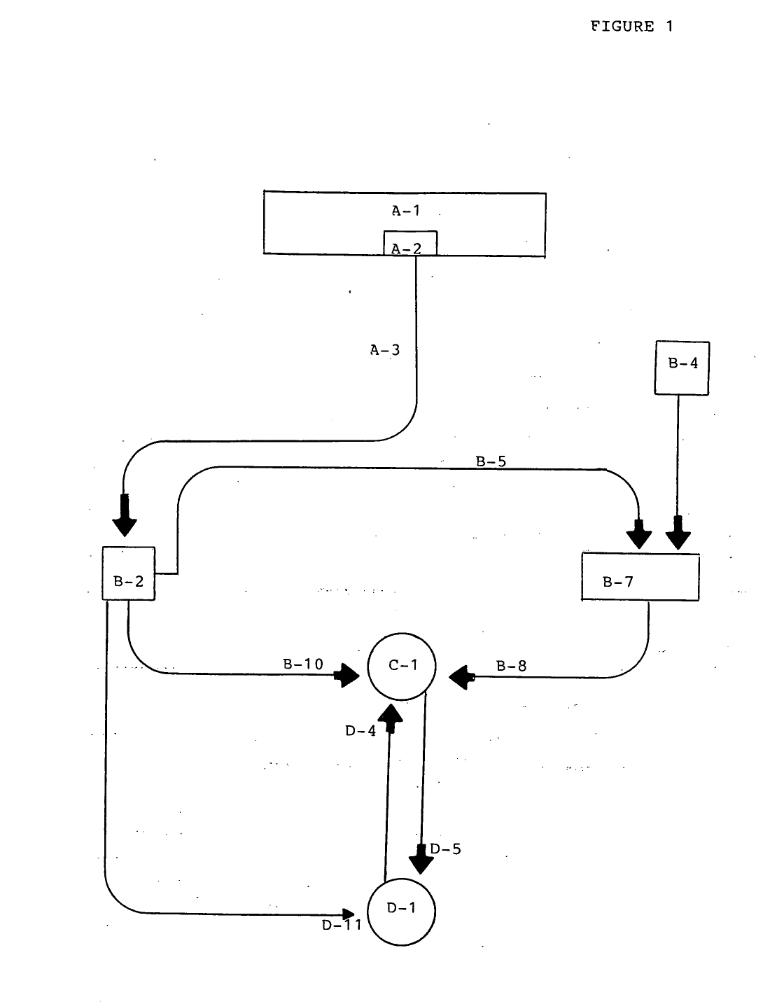

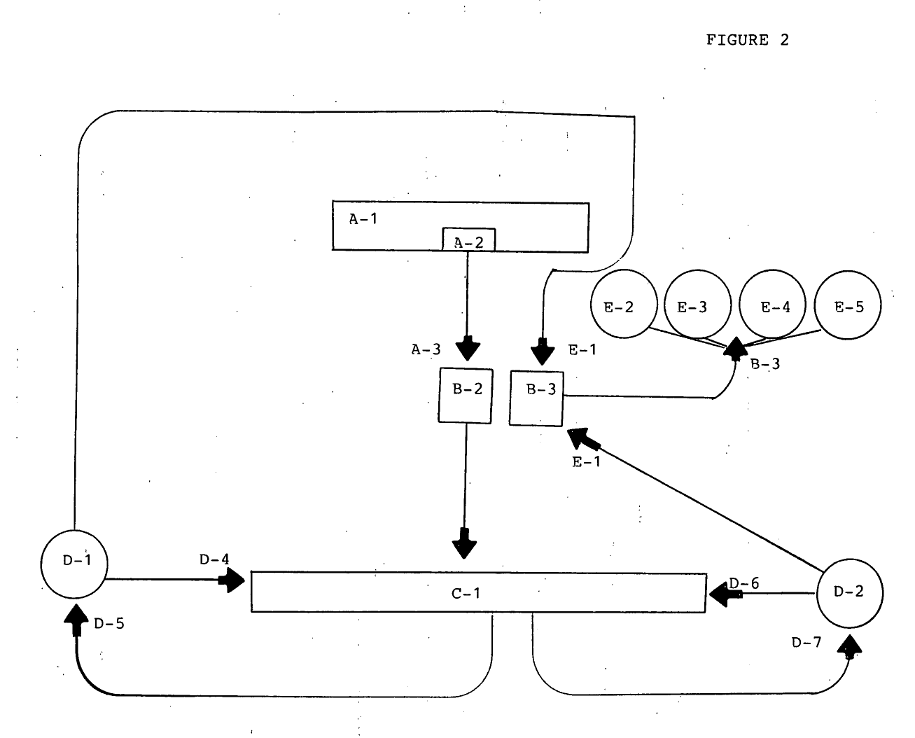

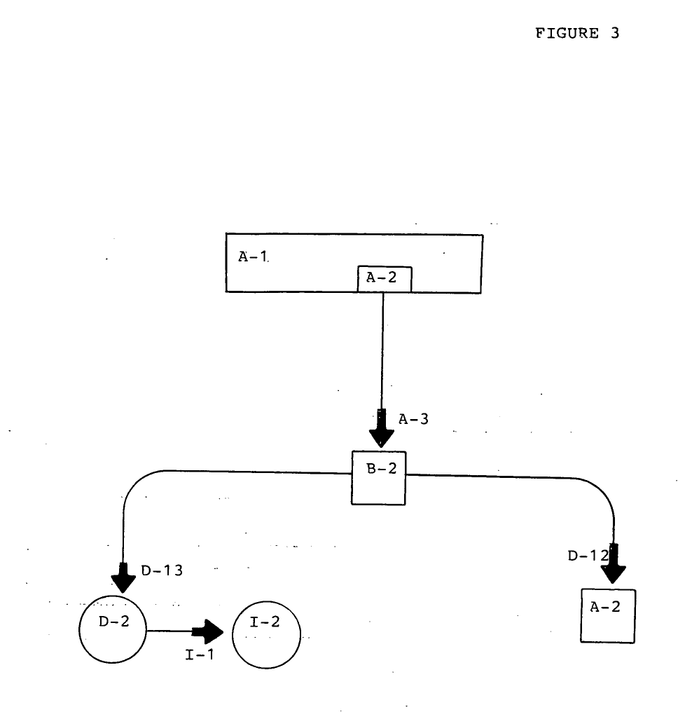

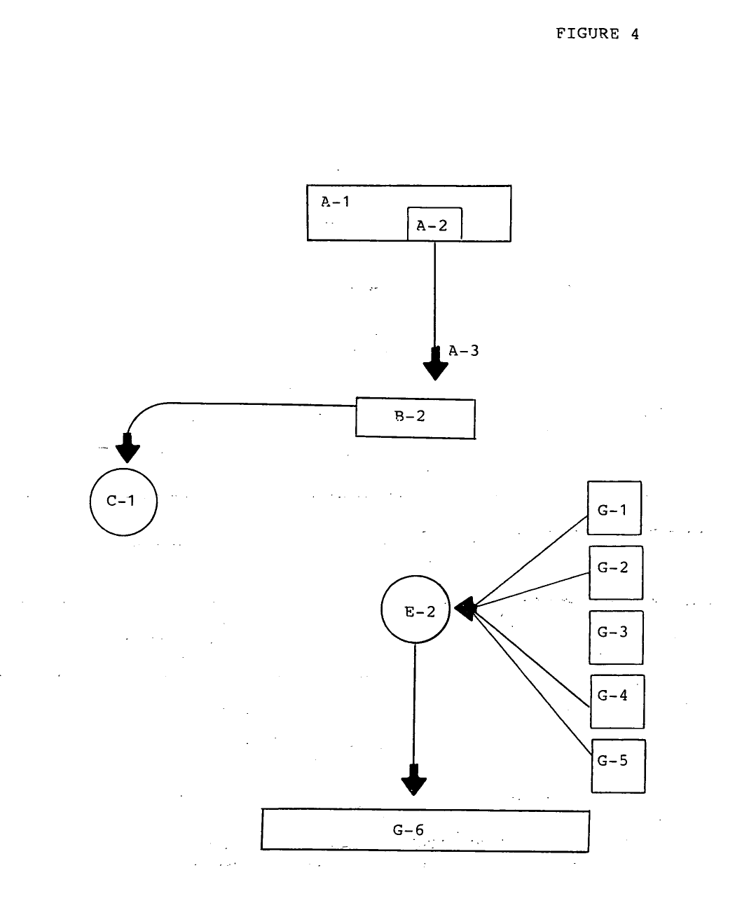

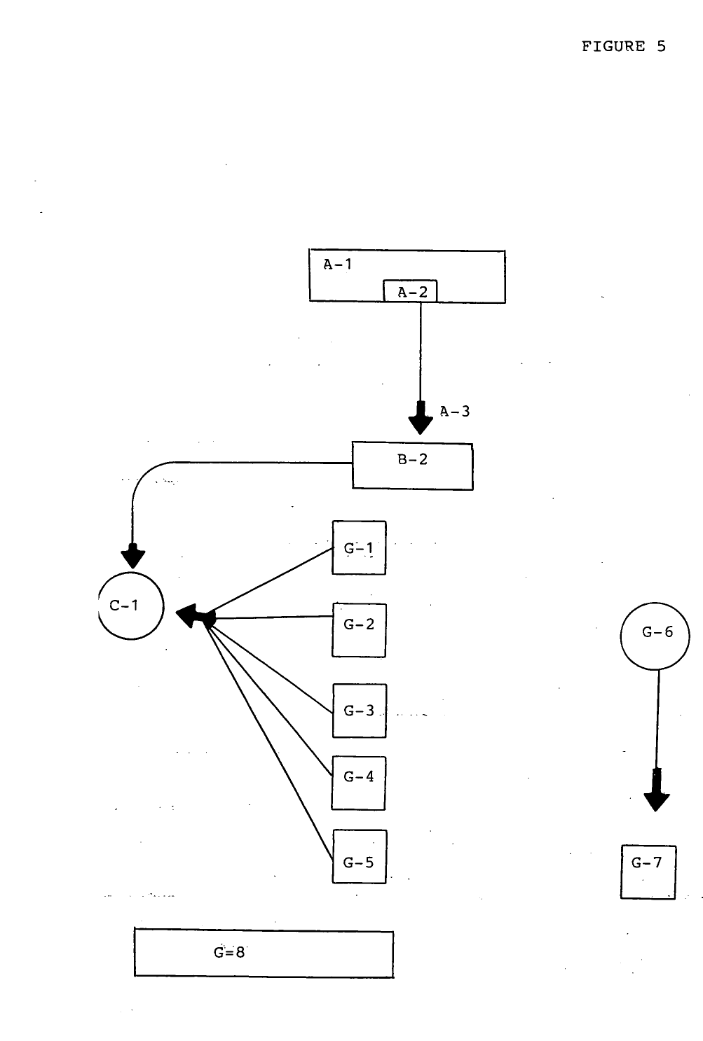

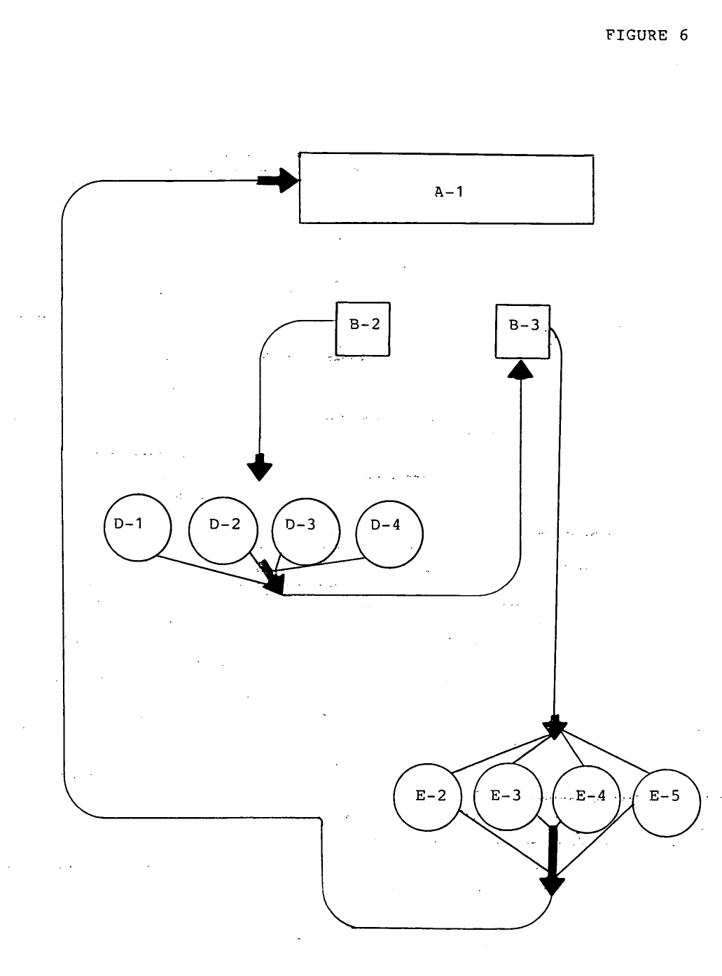

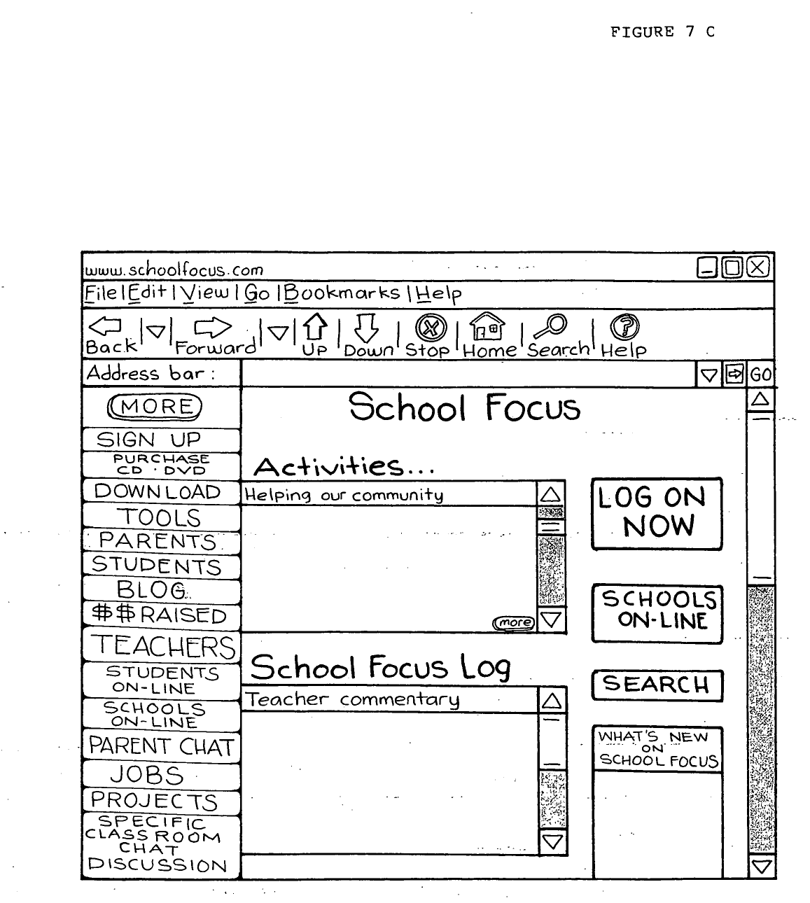

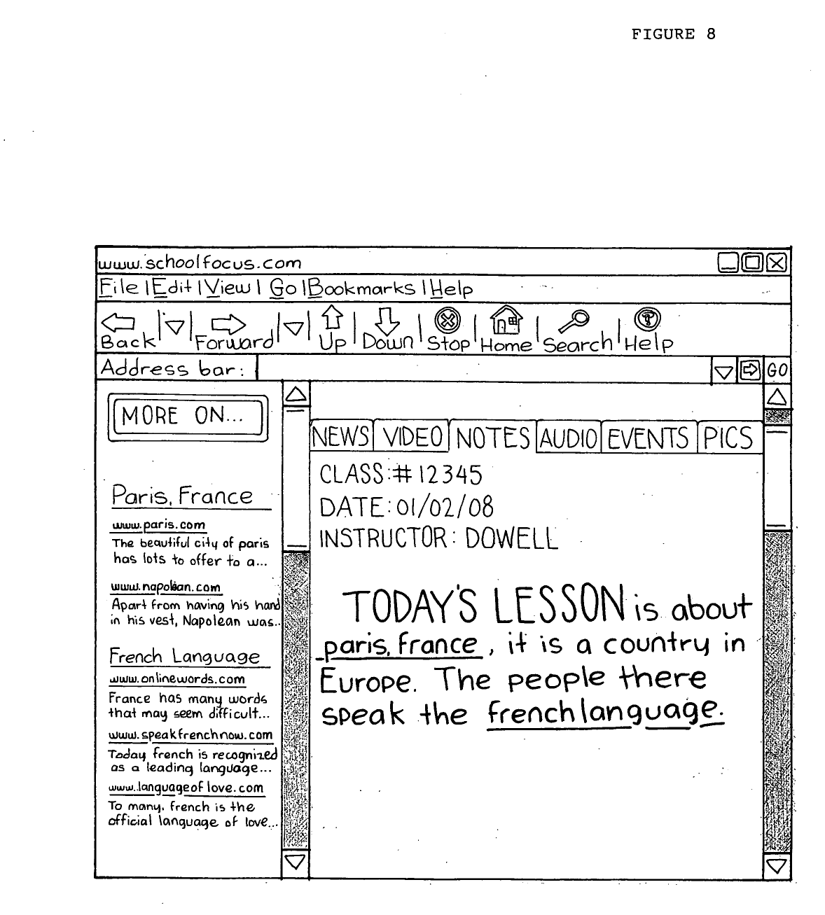

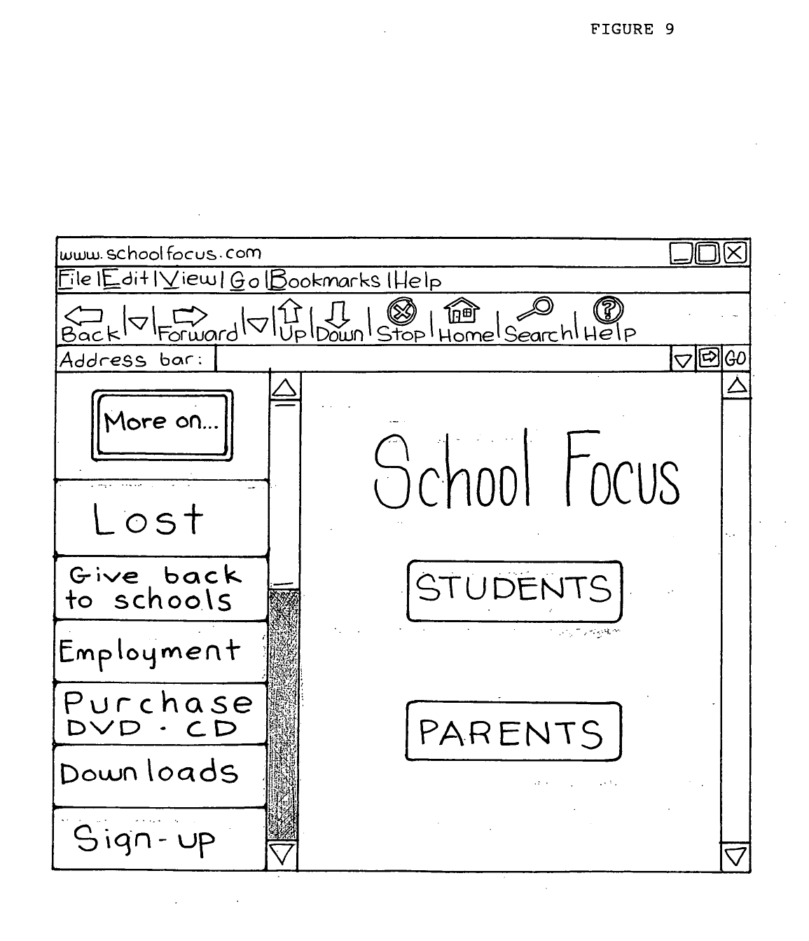

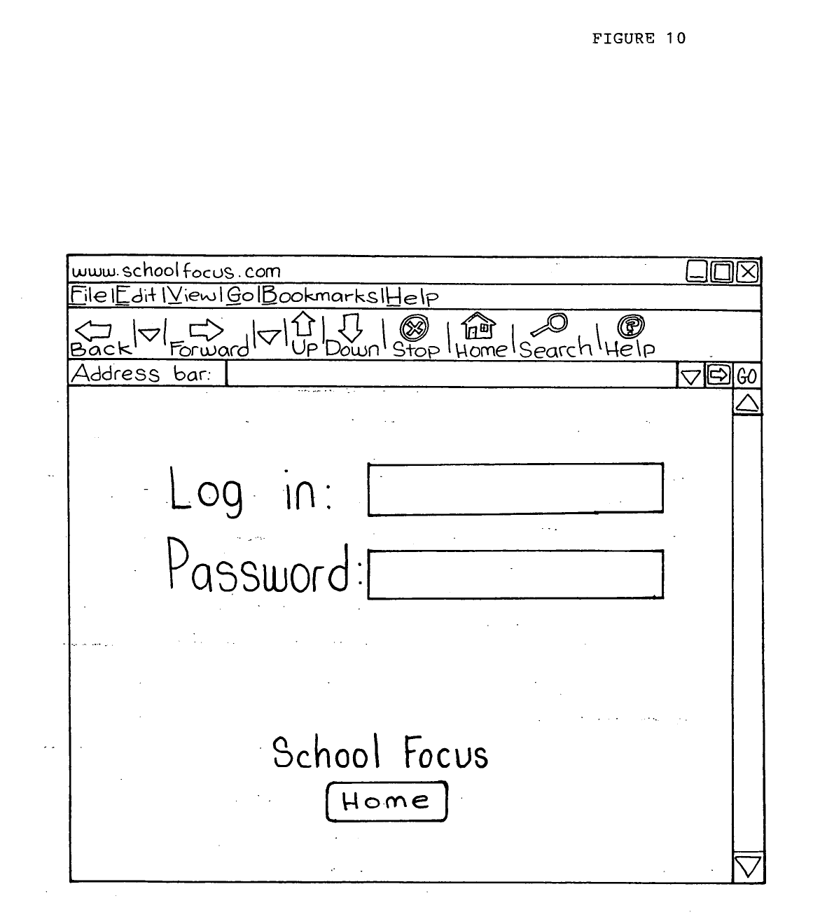

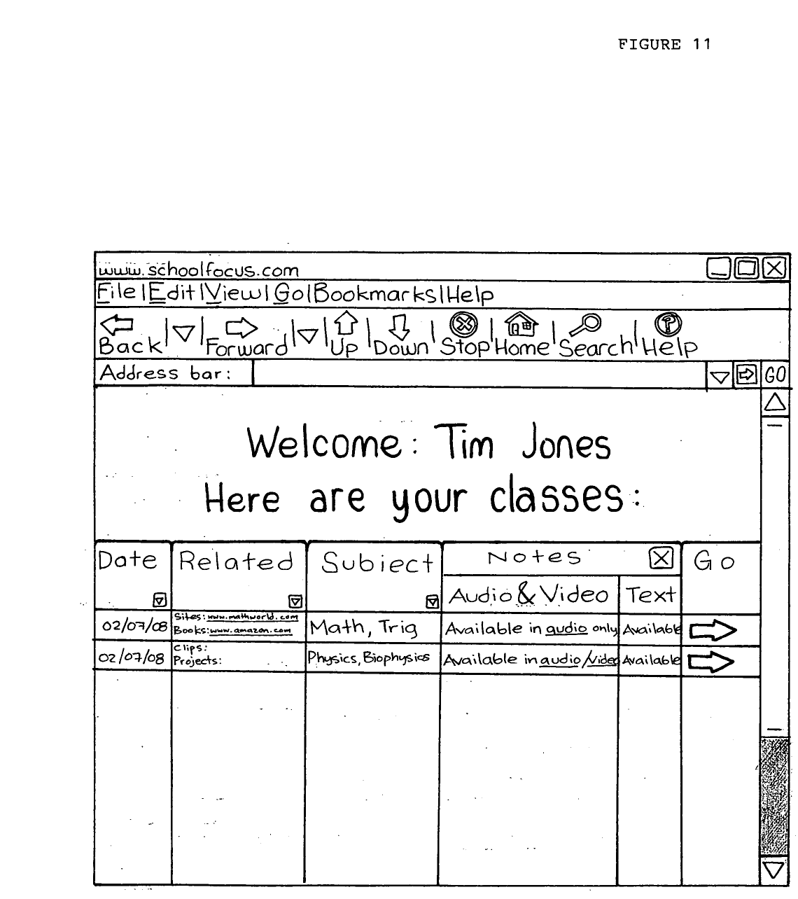

Teachers who implement this product will save millions of hours of productive planning and more effectively will be able to work with each student. FIG. 4 depicts the schools A-1 have systems that record audio and video A-2. The audio and video is forwarded to School Focus technology department B-2. When students have questions G-1 or when they can not understand the lesson G-3 they can log onto C-1 the home page of School Focus where they can obtain a repeat of the lesson in video and audio formats. They can also pring or have downloaded text notes with additional links to other web pages.

The United States will not suffer from poor education and pass rate, because students will be able to comprehend the lessons easier. The economy will also improve and regain position as one of the most educated students.

Teachers will not be overworked or stressed out as a result of the many requests from the many different students G-8.

FIG. 5 The effects of over worked teachers

This drawing depicts what happens when teachers have to much work and not enough time. Students G-1 have questions when encountering a difficult task or assignment. Due to this query students had no options other than ask the instructor for review and re-explanation of the lesson taught. Teachers E-2 ate over loaded with work G-2 and as a result of the exceeding work load students suffer from not having educational support, poor test results G-4 and thus the school performs poorly. The United States suffer from poor education resulting in a negative effect to our country and economy.

FIG. 6 New manner to raise millions of dollars for teachers school, state and federal government.

Classrooms across the United States A-1 sends audio and video signals to School Focus Technology department. School Focus Technology department. School Focus technology department provides products and services to users of its notes and services which are used by D-1 students, D-2 parents, D-3 doctors and medical professionals and D-4 educators and social reformers. These groups pay B-3 School Focus financial department for products and services. A percentage of the profits are divided amongs E-2 teachers, E-3 schools, E-4 state government and E-5 federal government.

FIG. 7 School Focus home page.

This drawing is the home page of what parents, students and other interested users will see when they log onto the home page of School Focus. This page is composed of the topics that will be found on the main home page of School Focus.

FIG. 8 Power notes

This drawing depicts the notes after they are transfered from audio into text. This note will show links of other web sites that have relevant information to the lesson that the professor was teaching on. This is an example of a lesson of Europe and its countries. Where the instructors topic is Paris, France. The word. Paris, France is underlined and a link is shown to other relevant web pages that can be helpful to the student if he or she is doing further research. This is the additional feature added to the conversion of the audio into text. The entire lesson is printed and recorded on digital and paper formats.

FIG. 9 Login Page

This drawing depicts the users who can benefit of this service and this category applies to students and parents. Other login site exists for other users.

FIG. 10 Password and Name entry section

This is an internet page that shows the need to type your log in name and password to access the web site.

FIG. 11 Audio, Video and Text Notes

### DETAIL DESCRIPTION OF THE PREFERRED EMBODIMENT

School Focus is an internet driven technology. This unique invention captures audio and video feed through its microphones and video cameras. The signal is sent through the internet to the School Focus server. The server stores the information in a database which is listed by name of school, date, class, time and instructors name.

Once the information reaches the server it is transcribed and stored on the database on a text format. The information compiled and stored on the database consists of audio, video nd text formats. Students can log onto the School Focus website and download any version whether audio, video, text or all.

School Focus is a system that is composed of a computer that has internet access. Connected to it are 3 to 5 cameras and microphones. The amount varies depending on the classroom. These devices upload the media through an internet connection. The cameras and microphones are placed where it can easily record the sound and activity of the teachers and students. The cameras will capture as much as permitted by law.

School Focus cameras will capture sufficient material to be able to view as the entire lecture was given. The microphones will also capture enough information to record the entire material both lectures and students questions. The School Focus computer system is able to sustain a high speed internet connection with an internet service provider.

The School Focus computer system consist of an ATX tower case with 500 watt power supply. An ideal SLI 600 watt power supply shall provide maximum function and is recommended to properly power the School Focus computer system.

The minimum School Focus system is compiled by the following items, settings, and electronics. The ideal School Focus computer system shall constitute of a 2.4 Ghz Intel Core 2 Quad Q6600 processor, 3GB 667-MHz DDR2 SDRAR 4 320 GB 7,200-rpm SATA hard drives in a RAID 0 array, 256 MB n Vidia GeForce 8400 GS graphic card. A compatible web cam that can capture video and upload it onto the internet. The School Focus system can work with a 56K modem, however an 802.11a/b/g/ wireless PCI network adaptor is recommended.

The School Focus computer system is required to support and have installed a video card that can support multiple video imputs. The multiple video imputs are for capturing the video feed from the multiple web cams placed throughout the classroom.

The School Focus computer system shall support multiple USB 2.0 ports. The ideal web cam is a HP 2 megapixel, 30 frames per second on USB 2.0. The School Focus computer system will work with most web cams. The placement of the cameras will be adjusted if a lesser quality camera is used.

The School Focus computer system supports audio feed from most microphones that are compatible with any of the following operating systems Red Hat, Windows 98, 2000, Me, XP, Vista, Ubuntu Linux or any other operating system including Google Apps. This system is referred to as the School Focus computer system and it will capture all audio and video within the class.

The School Focus computer system supports Red Hat, Ubuntu Linux and are the ideal operating system that drives School Focus technology. The School Focus computer system also can work well with all forms of Microsoft Windows including Windows 98, Windows 2000, Windows ME, Windows Xp and Windows Vista.

The School Focus computer system shall work equally well with most power cords, key boards, or mouse. Any generic brand will be sufficient to run the minimal tasks of loading software and trouble shooting. The ideal keyboard is a Logitech cordless MX 3200 Laser and an ideal mouse is a G3 Laser Logitech mouse.

The described School Focus computer system is placed inside the classrooms across the United States. Its components including cameras and microphones are also placed inside the classroom. This computer sustains an internet connection which sends the audio and video through the internet connection onto a School Focus server.

Once the audio and video feed is received School Focus converts the audio into text attaches links to other web sites that have relevant information and material to the notes and then publishes the material online and email them to registered users. Once it receives an order for monitoring of the student it snaps pictures of a specified area within the classroom where truant students are placed and emails the photos to the parents of the students. The conversion of audio into text will be done manually and by software. Current software that converts voice to text will be ideally appropriate.

A section will be created on the website to indicate that the notes are made available and in what format they are placed. The focus of this company is to place notes in text, video and audio format with instructors comments. Dates of notes and other pertinent information relating to the classroom activities.

After the audio is converted to text School Focus will make the text available for emai and make it accessable on its web page. The text notes will include references to other web sites that have information on topics taught for that perticular day. The attachments will include hyperlinks to other sites.

Once the web site links are attached to the notes and made part of the notes, then they are ready to be emailed in text, audio, and video formats. These notes and media formats are emailed to all internet capable devices including but not limited to cell phones, palm desktop accesories, sidekicks or any other hand held internet ready device.

Students who wish to obtain the notes and materials on School Focus home page can log onto the the home page by obtaining a password and subscribing to the service for a monthly or yearly membership cost. Once a student is registered the student has the option to have automatic emails with the material sent to him as they are made available. Students can select an automatic email option which sends daily lessons to the electronic device or computer from where the student would like to receive his material.

Students who wish to view the entire lesson on video with full audio capabilities, play back, rewind, fastforward, and loop can log onto the School Focus website and obtain required material at any time they wish. The selected lesson or class will play in its entirety or portions thereof. Students can also print out the entire notes verbatim of the class or can print out the section they need.

A student who wishes to log onto the School Focus web site will be given a login name and password that are required to be inserted before logging in. School Focus will provide the login names and passwords to the deans of the school or to other educators, law enforcement to monitor legal compliance.

The School Focus system works as follows. A student arrives at the home page of School Focus. The student can read about School Focus or can log in with a user name and password. Once the student logs in a list of the classes which he attended will appear on the screen. Students will be able to select the class or classes he wishes to view, listen to or read as was spoken by the instructor. A name of the class, instructor date will be listed with the format in which he wants to receive the information. Once the student makes his selection the command will automatically respond according to the requests and will either play the class or email the converted audio to text to the student. Students have options to fast forward, rewind, pause, loop or read the lesson and they will also have the option to surf the internet according to the links placed in the notes. These links will have relevant web sites which can further help the student in his understanding of the lesson. This is also the feature that is called power notes.

A parent who is using the School Focus system can monitor the attendance of the child or student. The parent will need to log in to the site and enter his password and log in name like a student, however the parent can select the option of attendance monitoring. Once the parent selects this option School Focus will send an instruction to its cameras which are placed in the classroom to snap pictures of a specific student. School Focus will first obtain authorization from the parent and will forward it to the instructor. Once the instructor confirms the request then School Focus will submit to the parent the photos taken of the student who is being monitored for truancy.

The School Focus system will snap 3 pictures of the student during the class. The pictures will be taken at different times throughout the day. Each photo will have a time stamp and date attached to it when it is captured and when it is sent.

Schools and law enforcement agencies can also request this service to better monitor law breaking students. The same stamp with the time and date will also be forwarded to any requesting law enforcement agency or monitoring body.

School Focus saves teachers, instructors and other educators millions of hours across the United States. School Focus saves these instructors time by not having to re-explain the material taught several times a day. Teachers instructors and other educators now can have a student listen to the lesson to a lesson that was recorded previously and that is stored on a School Focus web site.

In the past students did not have the options of receiving a re-explanation of the class at their time or when they were able to dedicate some study time to the matter which was unclear. With School Focus the ability to receive the material and information is now possible at their time and not when the teach is ready.

School Focus systems assist in saving teaches time by allowing substitutes to be able to access the material and information when they are going to be temporarly taking a class over. A substitute teacher now can review the lesson before arriving at the school.

Teachers will be able to stay on schedule and not have to cram any lessons into a smaller time period. This happens as a result of having the students log on to the website of a previously recorded lesson. If a teacher has used School Focus and the same curriculum is being taught then students can at least study on the material missed.

School Focus saves teachers millions of hours by providing the students the entire lesson, instructions and teaching as spoken by the classroom instructor. Students now can access the website when they are ready to receive the information. Students can easily absorb, retain and comprehend the material faster and better when they are ready to receive it instead of when the teacher has time to re-explain it.

Since the discovery of School Focus teachers across the United States are no longer required to deplete millions of hours in repeating, re-explaining, or going over material taught in class. The many students and their requests consume millions of hours of the instructors time. The time consumed is on redundant explanations. Teachers now have a tool that will repeat the entire lessons, lectures, and discourses. Teachers across the United States will save millions of hours of their time, because they will not need to repeat their lessons nor will students ask questions about a lesson that has been captured on School Focus systems. Teachers can lead students to the web site and students can have the entire lesson provided to them. Students also can access the information, lesson and lecture without asking the instructor for their time or for a re-explanation.

School Focus has discovered an income stream for schools by generating revenue from the sale of products and services and by raising thousands of jobs in various fields including systems maintenance, quality control, security, programming, network administration and many other clerical and technical positions. The creation of these jobs and incoming revenue will be appropriated to various schools, teachers, state government and federal government.

School Focus will also assist schools in keeping more of their money by allowing their students to be encouraged to go to school because of the attendance monitoring and because of an easier learning structure.

The contents of this page are intended to summarize the description of the preferred embodiment. School Focus is an invention that was created to help schools, teachers, students and government create an income generating stream and a better manner of studying classroom lectures. School Focus is also a product that detours the truancy of younger students.

School Focus is an invention that consists of computer systems which have connected to them web cams and microphones. These computers record audio, video and upload them through a internet connection, high speed or dial up and transfer the data to School Focus servers. The computers also take pictures of specific sitting areas that monitor the attendance of students and uploads the pictures the same way that it uploads the audio and video. Once the School Focus servers receive the media the media then is converted to text and its linked with other relevant web sites that contain information consistent with the daily lessons and the daily upload.

School Focus prepares the converted audio into text and includes the links and reference sites and places them on their web site and emails them to students or other requested users. Once the material which consists of audio, video and text transcribed from the audio are created students and other users can access the web site with a username and login name to select the various options on which they would like to receive the lesson. These include view online or have automatic downloads or selection of a specific area and download or copy that perticular area only.

School Focus will charge the users for its services and will divide the profits amongst the various teachers, schools, state government and federal government. It will also create a number of jobs for employees that currently are unemployed.

1. What I claim as my invention is the discovery of a new academic tool which combines the internet, computers, microphones web cams, internet access, transcription software, manual transcription and email to create an automatic note taking academic tool, utility and product. The combination of the above components together form a tool which records audio and video from classrooms across the United States uploads it to a computer and server through an internet connection. Once the audio and video is received the audio is transcribed into text and emailed to students or other users and it is stored and made accessable to students and other users who are studying or reviewing the topic of the lesson taught.
The combination of the above components create a new and unique note taking tool. This tool creates notes and converts them into a digital format which can be carried on cell phones, hand held internet ready devices such as ipods text readers, mp3 players and many other related gadgets.
This invention eliminates multi tasking, paper notes, note books, weight on back pack, pencils, pens, fragility of paper notes, the easiness of loosing paper notes, and the fact that once the physical note is lost it is lost forever.

2. What I claim as my invention is the electronic note, which can be emailed to cell phones, emails, ipods or any other hand held internet ready devices. The electronic note contains links to other websites which offer more information, background, and supporting relevant information combined with web sites, history, schools and all information supporting key topics or words. A student who reviews an electronic note is given additional information to re-enforce the lesson. With the electronic note a student does not have to rely on his own memory and hand written notes. Electronic notes are verbatim of the lessons taught. A word for word record instead of a tiny record.

3. What I claim as my invention is a discovery of a product that fixes the problem with classroom notes and note taking in classrooms or settings where lessons are taught and people keep record of the material taught. The first claimed benefit of this invention deals with the fact that notes are only a condensed brief entry or log of a huge lesson. It is impossible for a student to write down every important instruction given by the instructor inside the classroom. This claim also covers the amount of teaching, instruction and material lost by the student due to the inability to write it down.
The above described problem produces a lack of understanding and greater student failure. This invention claims that it puts an end to small, condensed notes and brief entries of the lessons, instructions and teachings of the instructor. It accomplishes this by taking notes of the entire lesson, teaching, and instruction. This invention does the work of taking the record in a full and complete word for word as spoken by the instructor. A student no longer is required to record brief entries of the lesson because the School Focus product will convert all audio received by the instructor into text and will email it to the students immediately. When students review the word for word lesson on the computer they can search a key word and the computer automatically finds and highlights the selected word. These are features found in most word processors and computer programs that already exist in the market.
This claim also fixes the problem with students taking notes while paying attention to the instructor, because while paying attention to the instructor a student is required to listen and remember what is being taught, organize his thoughts on what he wants to write, think of letters that he will use to compose words that will record a brief entry of the lesson taught, take their eyes off the instructor, look down onto a desk focus, grab a pen, focus on spelling, coordinate his hands and memory of the lesson all while maintaining focus on the teacher and while maintaining attention on the ensuing lesson. The problem that this product claims to fix is the resolution to correct, eliminate and do away with the combining of multi tasks when a student is taking notes. The problem of combining different tasks while paying attention to the instructor is eliminated when a student does not have to take notes during the learning process. When a student is not required to take notes no loss of focus, concentration or deprivation of learning readiness is encountered and thus no loss of conscious receptivity.
This product under claim one creates the possibility to let the student give his undivided attention to the instructor and not worry about the multi tasks encountered when a student is taking notes. This claim also covers the need to carry from class to class pens, pencils, notebooks and erasers, because the need to write down condensed records of the lesson will no longer be required. This claim also covers the reduction of weight on the back packs, because students carry several notebooks from class to class which will no longer be required, thus eliminating and alleviating the weight on their back packs.
This claim also covers the elimination of paper notes and their vulnerability to being lost or damaged. That once a paper note is lost or damaged it is gone forever. No longer will the impending problem of lost or damaged create a threat because if the notes or back packs are lost the notes can be re-printed at another later time. Since all records of classrooms are kept on the School Focus web site students have access 24 hours a day 7 days a week to obtaining their notes and re-printing them.
Another benefit under this claim is that notes are no longer wrinkled, un-presentable or raggedy because they can be printed like new at any time.
This claim also eliminates the need to waste paper, because with current note books students do not always use the entire note book, thus many pages go unused and waisted. This only uses the needed paper to keep notes and not have hundreds of additional unused paper lingering around.

4. What I claim as my invention is the placement of computer systems inside classrooms with an internet connection, web cams, and microphones which combined create a new tool used for raising millions of dollars for schools, teachers, state government and federal government. The new discovered combination will also create a note taking tool which emails complete transcription of the entire classroom lesson. The combination of the above mentioned components together eliminate the need for students to pay attention to the teacher and while paying attention a student is required to focus on listening and remembering what is being taught and while remembering what is being taught a student is required to organize their thoughts, look away from the instructor down onto a desk, focus on spelling, pick up a pen, coordinate hands and memory of letters used to compose words depicting the lesson of the instructor all while maintaining focus and concentration on the ongoing ensuing lesson.
The combination of computers, which capture audio and video through its microphones, web cams and internet connection creates a tool which will also eliminate or greatly reduce class cutting, truancy and student's deliberate intention to skip class. The system is designed to snap photos of students who are sitting at a designated area. The photos will be emailed to parents who request this service. The combination of the aforementioned tools will gear parents up with real time knowledge of their child's truancy. This is a new product because in the past parents were not informed until much after the class was over. Parents were not informed until night time and into it was to late to intervene the truant conduct.
The combination of the aforementioned components will also create better grades, because students can receive a review of the lesson at a time convenient to them and not when the teacher is ready and the student is tired. The ability to provide re-explanation at the ideal time will create better absorption and understanding of the lesson.
This claims also asserts that the aforementioned combination of School Focus computer systems, web cams, microphones and internet connection will allow for media storage of classroom lectures by placing the lessons on Dvd, CD, Text, Mp3 and all other digital storage forms. The ability to record and make available word for word lessons is new product that for the first time in the internet and school history is only made available through this invention. The new manner of note storage can be seen in the electronic devices such as phones ipods, computers, email, online, and any and all other internet ready devices, or other electronic components.

5. What I claim as my invention is the new combination of notes and email, and their application and availability unlike any other note taking process and system. Students now can get notes when they are ready. Students in the past needed to ask their instructor for re-explanation of the lecture this re-explanation took place at the instructors time which was not the best time for students. Students now get notes and re-explanation when they are ready and most receptive to absorb the material taught.

6. What I claim as my invention is the combination of the internet, computers, web cams, microphones and a internet connection with transcribing software and manual transcribers to create a new and unique academic utility. That the above combine to create transcription of the lessons given by the instructors. The aforementioned combination of products combine to create a new product that will take notes for students and will email them to their electronic internet ready devices. Students will not need to re-write their notes if they are lost they only need to re-print them.

7. What I claim as my invention is the total improvement to notes and the note taking process, because no more multi tasking students will not need to take their own notes, electronic notes are lighter they have features which consist of audio, video, text with links to reference web sites, fast forward features rewind and loop. These notes can be emailed to internet gadgets, electronic components or any other hand held device. The notes are transcribed from audio to text which will be used to study in class rooms in the future or at home when a student is doing their homework. These notes are eliminating the need to carry note books and these notes will also reduce the need for pens and pencils in school. This total note is created by the web cams and microphones capturing the entire lesson and uploading it to the home site of the parent company where the information will be transcribed into text and placed on a database where users can access the content for future study. These new notes can not be lost or damaged because if they are they can easily be re-printed.

8. What I claim as my invention is a discovery of a product that will save teachers across the United States millions of hours of time. Teachers will not need to re-explain their lessons when a student wants a re-explanation. Students now can review a lesson over the internet without consuming the time of the teacher or without receiving the information at the teachers convenience, but at their convenience. Teachers can continue to teach their students according to their curriculum even if they are absent. A teacher can use a previous years recording or DVD, CD, or audio device to play the previous lesson taught the year before. Regardless of the teachers absence class will continue through the previous year recording. If a substitute teacher is to take over for a period they will have a better understanding of where to begin and what material has been covered the need to ask the regular teacher is no longer required thus saving them time in re-explaining lessons previously taught. Teachers will save millions of hours, because inquiring parents will not contact them as frequently with questions regarding the lessons or the childs behaviour. Teachers will not need to contact the parents of the children who don't show up to class.

9. What I claim as my invention is a new manner in raising millions of dollars for schools, teachers, and government. School Focus will create a new product such as DVD, CD, Audio, Wav, MP3 and text notes which will be sold to students or other users who need the information. A percentage of the money raised will go to schools

10. What I claim as my invention is one product that benefits the schools, teachers, state government and federal government while helping the students arrive at better grades and empowering the students to have better tools to pass successfully the class or classes that they attend.
This claim applies to all these benefits as follows. It is difficult for schools to raise money. Schools are constantly being cut down on their budget and incoming money for their expenses. That this invention under this claim asserts the new manner for raising money for schools through combining the need for notes, the internet, an Internet connection and fees that are charged to access the website. That never before has any product or invention combined the aforementioned components to raise millions of dollars for schools. This claim applies and works as follows. Students don't take notes in class. School Focus records audio and video through its web cams and microphones placed inside a classroom. The school focus system uploads all audio and video feed onto the internet through an internet connection onto the School Focus web servers. School Focus converts the audio onto text and makes text, audio and video notes available to all students over the internet. Students can have audio, video and text emailed to them as they wish. Students and parents pay a fee to acquire these services including the ability to purchase Dvd's, Cd's, and other digital and analog formats of the lessons and instructions captured by the School Focus system. The raising of this revenue will allow for schools to receive money that would not otherwise be raised. A percentage of this money is also divided amongst teachers, state and federal government. This invention claims that it has discovered a new manner in raising billions of dollars for schools, teachers, state and federal government.
This invention under this claim also asserts that it has saved millions of dollars to schools by improving a system of correcting and deturring the cutting of class, truancy and the intentional failure to attend class.

11. What I claim as my invention is the new method to reduce truancy which combines the internet, computers, email and internet access which works as followed. School Focus cameras will snap pictures of the students blur out the students who are not being monitored and email them to the parents and police department of the students who are not in class and should be. Parents will be able to more closely be informed of their childs truancy and will be able to more effectively deal with it. The combination of the above mentioned components will provide easy monitoring of student's attendance.

12. What I claim as my invention is the better developing relations of working parents or long distance parents. In the past parents who lived far or worked far could not easily be informed of their child's education. That in the past these parents were limited to their child's memory and thus as a result these parents could not re-enforce the lessons that their children were taught. Parents now are better equiped to discuss at home, the dinner table or other locations the material taught and the re-enforcement of their learning and education. Parents will not be excluded for lengthy periods of time. Parents will have better access to their child's education their learned material and their composure to class and their behaviour in class.

13. What I claim as my invention is the combination of school notes and automatic email in audio, video and text formats. Never has a product automatically emailed school notes to students or other users. This invention will make automatic email delivery once a student requests the automatic email delivery consisting of audio, video, text or all to cell phones, pda, hand held internet ready devices or computers.
